(19) United States
(12) Patent Application Publication
(10) Pub. No.: US 2007/0073770 A1
(43) Pub. Date: Mar. 29, 2007

(54) Methods, systems, and computer program products for resource-to-resource metadata association

(76) Inventors: Robert P. Morris, Raleigh, NC (US); Jared S. Fry, Boston, MA (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/239,276

(22) Filed: Sep. 29, 2005

(51) Int. Cl. G06F 17/00

(52) U.S. Cl. 707/104.1

(57) ABSTRACT

The subject matter described herein includes methods, systems, and computer program products for resource-to-resource metadata association. According to one method, a source resource and a destination resource are identified. A type of at least one of the source and destination resources is identified and used to select a transform for mapping data values associated with the resource to the destination resource as metadata. Based on the transform, at least one of the data values associated with the source resource is associated with a destination resource as metadata.

### RELATED APPLICATIONS

This application is related to a commonly-assigned, co-pending U.S. patent application entitled, “Methods, Systems, and Computer Program Products for Automatically Associating Data with a Resource as Metadata Based on a Characteristic of the Resource” (serial no. not yet assigned) and a U.S. patent application entitled, “User Interfaces and Related Methods, Systems, and Computer Program Products for Automatically Associating Data with a Resource as Metadata” (serial no. not yet assigned), both filed on even date herewith, the disclosure of each of which is incorporated herein by reference in its entirety.

### TECHNICAL FIELD

The subject matter described herein relates to methods, systems, and computer program products for automatically associating data with a resource as metadata. More particularly, the subject matter described herein relates to methods, systems, and computer program products for resource-to-resource metadata association.

### BACKGROUND ART

In computer file systems, files are used to store data created by users, software applications, and devices. In addition to user-created content, a computer file may be associated with descriptive information regarding the contents or other aspects of the file. This descriptive information is referred to as metadata. In some instances, metadata is stored in the file. In other instances, metadata is stored outside of the file but is linked to the file.

Some application programs allow users to manually create and associate metadata with a file. For example, digital image organization programs sold with digital cameras may allow a userto manually enter captions to be stored and/or displayed with an image. While such manual metadata creation tools are useful, they require unnecessary time and labor on the part of the end user, because the end user is required to manually input the metadata for each resource.

Some current computer operating systems include limited functionality for automatically associating file system information with files. For example, the Windows® 2000 and Windows® XP operating systems automatically associate a file's location in a file directory tree with the file in response to the file being stored in a particular directory. However, the Windows® 2000 and Windows® XP operating systems do not allow mapping between data or metadata of one resource type to metadata fields or tags of another resource type where the data is independent of location information used by the file system to identify a file's location.

Newer operating systems include file systems that are more database-oriented than previous operating systems. For example, the Longhorn operating system expected to be released by Microsoft in 2006 includes an unstructured file system and a structured file system. The unstructured file system is the same NTFS file system included in Windows® 2000 and Windows® XP. The structured file system is a database-oriented file system in which file properties are stored and organized as structured database objects. When an application modifies unstructured properties of a file, structured database objects corresponding to the unstructured properties are updated. The process of updating the structured database objects is referred to as promotion. However, the promotion process only maps existing unstructured properties of the file to structured objects maintained by the structured file system. There is no ability in the promotion process to automatically map and associate file-system-independent data from one resource of one type to another resource of the same or a different type. In addition, there is no ability in the promotion process to automatically associate data from one resource as metadata in another “destination” resource, where the metadata is independent of an association between the destination resource and a file system for storing the destination resource.

Accordingly, there exists a long felt need for methods, systems, and computer program products for resource-to-resource metadata association.

### SUMMARY

According to one aspect, the subject matter described herein includes a method for resource-to-resource metadata association. The method includes identifying the source resource and identifying an existing destination resource. A type of the source and/or the destination resource is also identified. Based on the type, a transform is selected for mapping at least one data value associated with the source resource to the destination resource as metadata. Based on the transform, a data value associated with the source resource is associated with the destination resource as metadata. The metadata is independent of an association between the destination resource and a file system for storing the destination resource.

The subject matter described herein for resource-to-resource metadata association may be implemented using a computer program product comprising computer executable instructions embodied in a computer readable medium. Exemplary computer readable media suitable for implementing the subject matter described herein include disk memory devices, chip memory devices, programmable logic devices, application specific integrated circuits, and downloadable electrical signals. In addition, a computer program product for implementing the subject matter described herein may be implemented on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a flow chart illustrating exemplary process for resource-to-resource metadata association according to an embodiment of the subject matter described herein;

FIG. 2 is a block diagram illustrating an exemplary system for resource-to-resource metadata association according to an embodiment of the subject matter described herein;

FIGS. 3A and 3B are a flow chart illustrating an exemplary process for resource-to-resource metadata association according to an embodiment of the subject matter described herein;

FIG. 4 is a block diagram of an exemplary protocol handler according to an embodiment of the subject matter described herein;

FIG. 5 is a block diagram illustrating an exemplary content handler according to an embodiment of the subject matter described herein;

FIG. 6 is a block diagram illustrating a portion of an exemplary database for storing metadata apart from a resource according to an embodiment of the subject matter described herein;

FIG. 7 is a block diagram of a portion of an exemplary database for storing data apart from a resource according to an embodiment of the subject matter described herein;

FIG. 8 is a block diagram illustrating an exemplary database for storing resource metadata apart from a resource according to embodiment of the subject matter described herein;

FIG. 9 is a block diagram illustrating an exemplary desktop or application pane demonstrating user action for resource-to-resource metadata association according to an embodiment of the subject matter described herein;

FIG. 10 is a block diagram illustrating an exemplary desktop or application pane demonstrating user action for resource-to-resource metadata association according to an embodiment of the subject matter described herein;

FIG. 11 is a block diagram illustrating an exemplary desktop or application pane demonstrating modal input for resource-to-resource metadata association according to an embodiment of the subject matter described herein;

FIG. 12 is a block diagram illustrating an exemplary desktop or application pane demonstrating a metadata mixer for resource-to-resource metadata association according to an embodiment of the subject matter described herein;

FIG. 13 is a block diagram illustrating an exemplary desktop or application pane for resource-to-resource metadata association where one of the resources is data accessible through an executing application according to an embodiment of the subject matter described herein;

FIG. 14 is a block diagram illustrating an exemplary desktop or application pane including a dialogue box for resource-to-resource metadata association according to an embodiment of the subject matter described herein; and

FIG. 15 is a block diagram illustrating an exemplary user interface for automatically exchanging metadata between a resource and a resource cluster according to an embodiment of the subject matter described herein.

### DETAILED DESCRIPTION

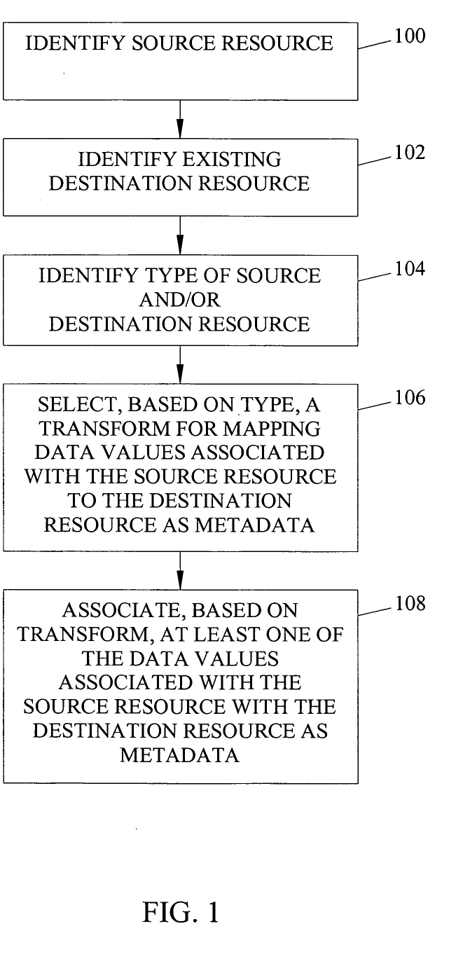

The subject matter described herein includes methods, systems, and computer program products for resource-to-resource metadata association. According to one aspect, a method or process for resource-to-resource metadata association is disclosed. FIG. 1 is a flow chart illustrating an exemplary process for resource-to-resource metadata association according to an embodiment of the subject matter described herein. Referring to FIG. 1, in block 100 a source resource is identified. The source resource may be a system file, application, or other resource recognized by a computer operating system. In block 102, an existing destination resource is identified. The destination resource may likewise be a system file, an executable application, or other resource recognized by a computer operating system. In block 104, the type of the source and/or the destination resource is identified. In block 106, based on the type of the source and/or destination resource, a transform for mapping one or more data values is associated with the source resource to the destination resource as metadata is selected. In block 108, at least one data value associated with the source resource is mapped to the destination resource as metadata.

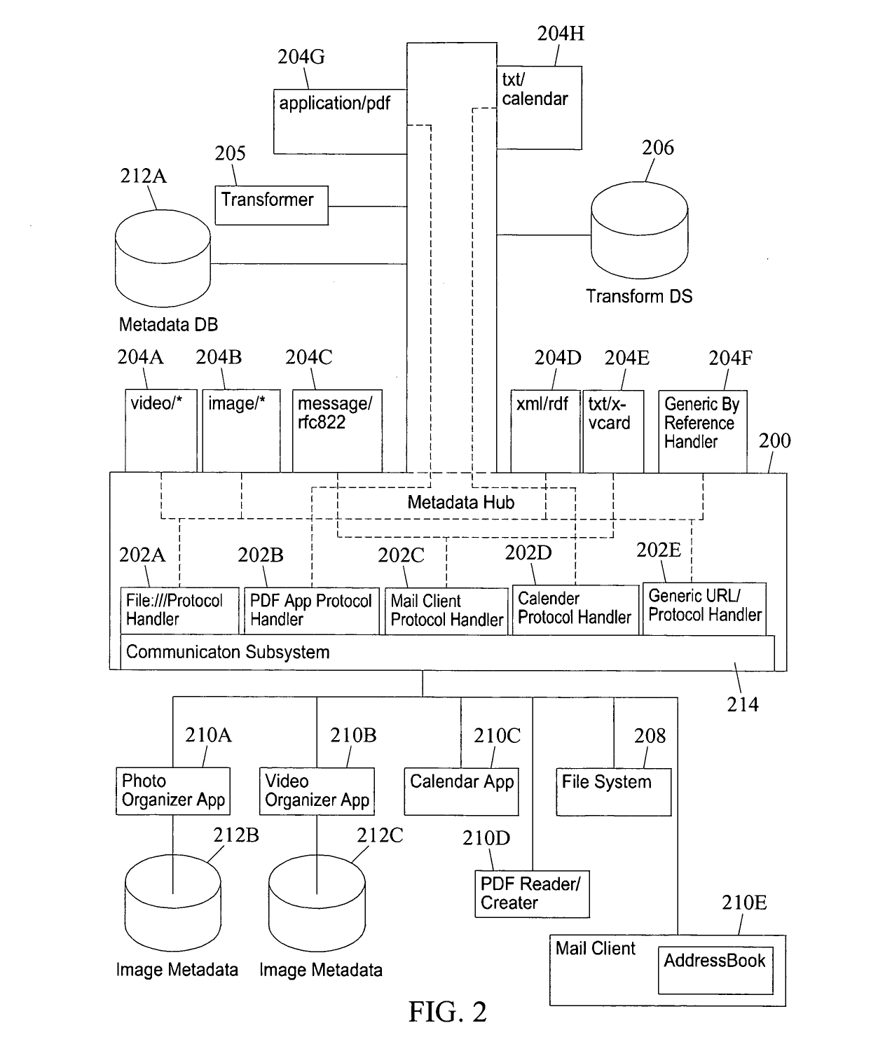

According to another aspect, the subject matter described herein includes a system for resource-to-resource metadata association. FIG. 2 is a block diagram illustrating one example of such a system. In FIG. 2, the system includes means for identifying source and destination resources and a type of at least one of the source and the destination resource. For example, metadata hub 200 may identify source and destination resource types and invoke an appropriate protocol handler 202A-202E that provides access to the source and destination resources in a resource-to-resource metadata transaction.

In order to identify source and destination resource types, metadata hub 200 may register itself with the operating system to receive notification when a metadata association action occurs. When such an action occurs, the operating system may communicate the source and destination resource identifiers to metadata hub 200. Metadata hub 200 may also include an application programming interface (API) that allows programmers to write applications that trigger hub functions. For example, an associate function that may be defined for metadata hub 200 may be accessed using the following call:
bool associate(source_res_id, dest_res_id, direction)
   The above-listed function call allows a programmer to trigger resource-to-resource metadata association by specifying the source and destination resource identifiers as parameters to the associate function. The resource identifiers may be. file names, process identifiers, or other suitable resource identifiers. The programmer may also specify a direction parameterto indicate whether the association is source-to-destination, destination-to-source, or both., The call may trigger hub 200 to perform resource-to-resource metadata association, as illustrated in FIG. 1. The associate function may return a different boolean value depending on whether the association is successful.

The system illustrated in FIG. 1 may further include means for selecting, based on the type, a transform for mapping data values associated with the source resource to the destination resource as metadata. For example, metadata hub 200 may invoke appropriate content handlers 204A-204H based on the source and destination resource types to access data and/or metadata associated with the source and destination resources. Metadata hub 200 may further invoke transformer 205 to perform any conversions between data exchanged between the source and destination resource types as metadata. The conversions may include data format conversions and mappings from source resource metadata fields to destination resource metadata fields. Transformer 205 may access one or more transforms stored in a transform data store 206 to perform the appropriate conversions. In one exemplary implementation, transformer 205 may be implemented using extensible style sheet transformations (XSLT). In alternate implementations, scripts and/or executables may be used.

The following pseudo code is an example of a transform that may be defined for mapping data from a document resource to an image resource as metadata:

1. image.subject=document.subject

2. image.photographer=document.author

3. image.caption=document.content

In line 1 of the pseudo code above, content of the subject metadata tag of the document is mapped to the content of the subject metadata tag of the image. In line 2 of the pseudo code above, the content of the author metadata tag of the document is mapped to the photographer metadata tag of the image. In line 3 of the pseudo code above, content from the document is mapped to the caption image metadata tag of the image. It should be noted that the content of the document may not be initially stored as tagged metadata. That is, transformer 205 may convert the content of the document to a tagged content field and automatically map that content to the captioned field of the image.

Metadata hub 200 may identify data items as candidates for exclusion for metadata association. For example, certain data associated with the source resource may not be appropriate for association with a destination resource as metadata. Metadata hub 200 may identify the data that is not appropriate for association with a destination resource as metadata when transformer 205 fails to map the data to the destination resource. In one example, if the source resource is an image file with metadata tags relating to the tint or brightness of the image, such data values may not be appropriate for inclusion in a document relating to the image. Metadata hub 200 may identify such data from the source resource as a candidate for exclusion and allow the user to manually determine whether to map or exclude the data value from association with the destination resource as metadata. Alternatively, metadata hub 200 may automatically exclude data from the source resource that does not map to the destination resource as metadata.

In one exemplary implementation, metadata hub 200 may present a user with a menu of source resource data values and destination resource metadata fields. The source data items presented in the menu may include all source data items, source data items that are determined to be appropriate for association with the destination resource as metadata, or source data items that did not automatically map to one or more destination resource metadata fields. The destination metadata fields that are presented may likewise be a complete set of metadata fields of the destination resource, a set of fields to which source resource data maps, or a set of fields for which source data mapping failed. After presenting the user with the menu, metadata hub 200 may monitor user input for association actions for associating source resource data with destination metadata fields and perform the user-selected associations. An exemplary menu that may be presented by metadata hub 200 will be described in detail below.

Content handlers 204A-204H understand the format of the data and the metadata and any rules or restrictions that must be enforced on both the structure and values of the data or metadata. Transformer 205 may apply a transform or chain of transforms from transform data store 206 where the input is provided by the source content handler and the output is compatible with the destination content handler. It is not required for the input to the transform to be the same format that the content handler receives. That is, the source content handler may perform a format conversion to make it compatible with the transform. Likewise, the output of the last transform is not required to be the same format as the destination. The destination content handler may convert the output from the transform to a format compatible with a destination resource.

The system illustrated in FIG. 2 may further include means for associating, based on the transform, at least one of the data values associated with the source resource with the destination resource as metadata. In FIG. 2, metadata hub 200 may invoke the appropriate content handlers 204A-204H and transformers 205 to associate data from a source resource with a destination resource as metadata.

In the example illustrated in FIG. 2, the system resources for which it may be desirable to perform metadata to metadata association include files accessible via a file system 208, or content accessible via one or more applications 210A-210E. For example, it may be desirable to associate data from a file in file system 208 with an address book entry accessible via mail client 210E or vice versa. Specific metadata association examples will be described in detail below.

In the example illustrated in FIG. 2, metadata is stored separately from resources in various metadata databases 212A-212C. In an alternate example, the metadata or references to the metadata may be directly associated or embedded in the resource. Either embodiment is intended to be within the scope of the subject matter described herein. Thus, when metadata hub 200 associates data from a source resource with a destination resource as metadata, metadata hub 200 may update the corresponding entry in one of metadata databases 212A-212C. In an embodiment in which metadata is directly embedded in a resource, metadata hub 200 may write the data or reference to the appropriate metadata fields within the resource.

The components illustrated in FIG. 2 may communicate in any suitable manner. In the illustrated example, a communication subsystem 214 provides the mechanism by which metadata hub 200 can access system resources 208 and 210A-210E as well as metadata databases 212A-212C. In one example, communication subsystem 212 may be implemented using a network communications protocol stack, such as a TCP/IP protocol stack.

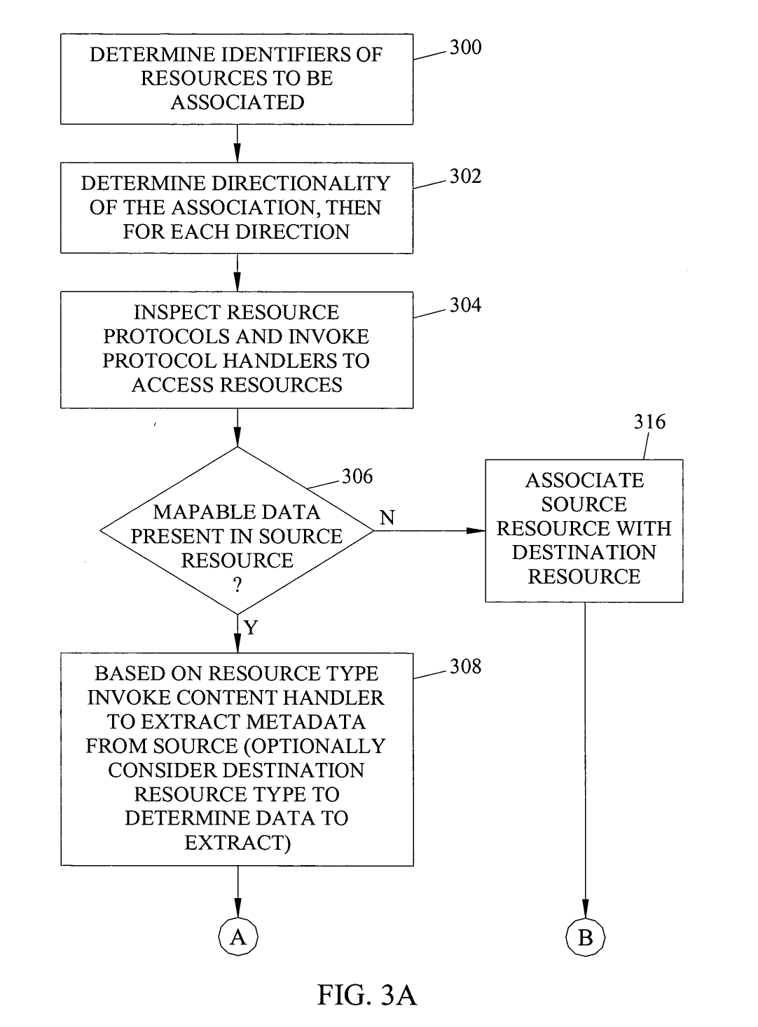

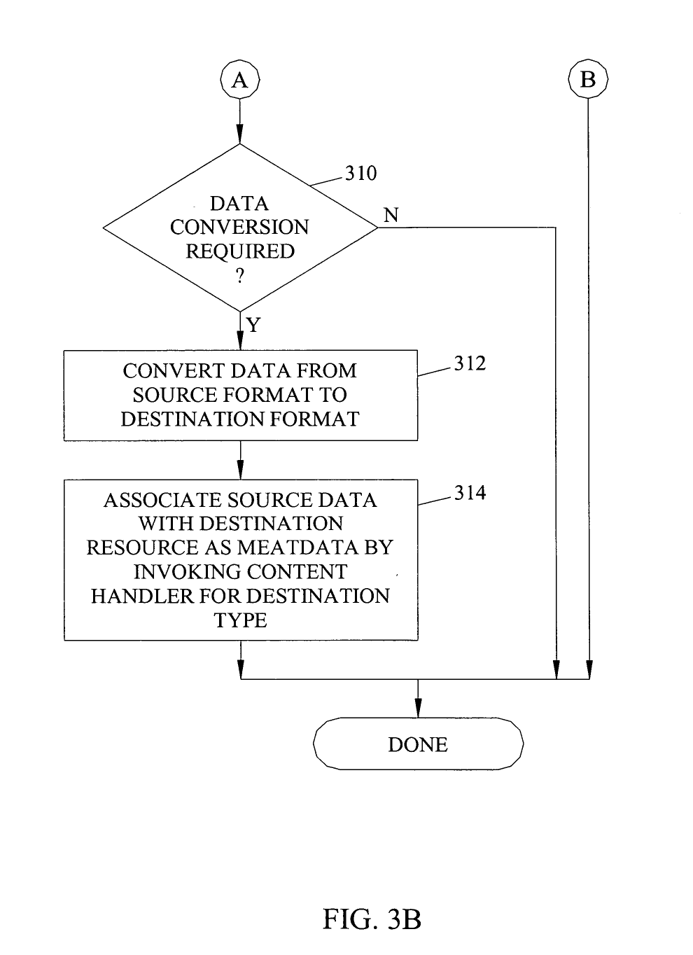

FIGS. 3A and 3B are a flow chart illustrating an exemplary process for associating data from a source resource to a destination resource as metadata using the components illustrated in FIG. 2. Referring to FIG. 3A, in block 300, identifiers of resources to be associated are determined. The identifiers may be received in response to selection of the source and destination resources by a user via a user interface. In block 302, the directionality of the association is determined, and, for each direction, the actions specified by the remaining blocks in FIG. 3 are executed. Directionality for metadata association may be source-to-destination, destination-to-source, or both.

In block 304, resource protocols are inspected and protocol handlers are invoked to access the resources. In block 306, it is determined whether any mapable data is present in the source resource. Here, the term “mapable data” refers to data in the source resource that is may be accessed by a source content handler mapping to a destination resource. If mapable data is present, control proceeds to block 308 where a source content handler is invoked. The source content handler may be invoked based on the source resource type to extract data from the source resource. The destination resource type may also be used to determine the source content handler to invoke and data to extract. Referring to FIG. 3B, in block 310, it is determined whether a data conversion is required. If a data conversion is required, control proceeds to block 312 where data is converted from the source format to the destination resource format. Block 312 may be performed by content handlers and/or transformer 205 as described above with respect to FIG. 2. After the data conversion is performed or if no data conversion is required, control proceeds to block 314 where source data is associated with the destination resource as metadata by invoking the content handler for the destination type. For example, the mapped data can be written to a metadata file associated with the destination resource. In an alternate implementation, the mapped data may be written directly to the destination resource.

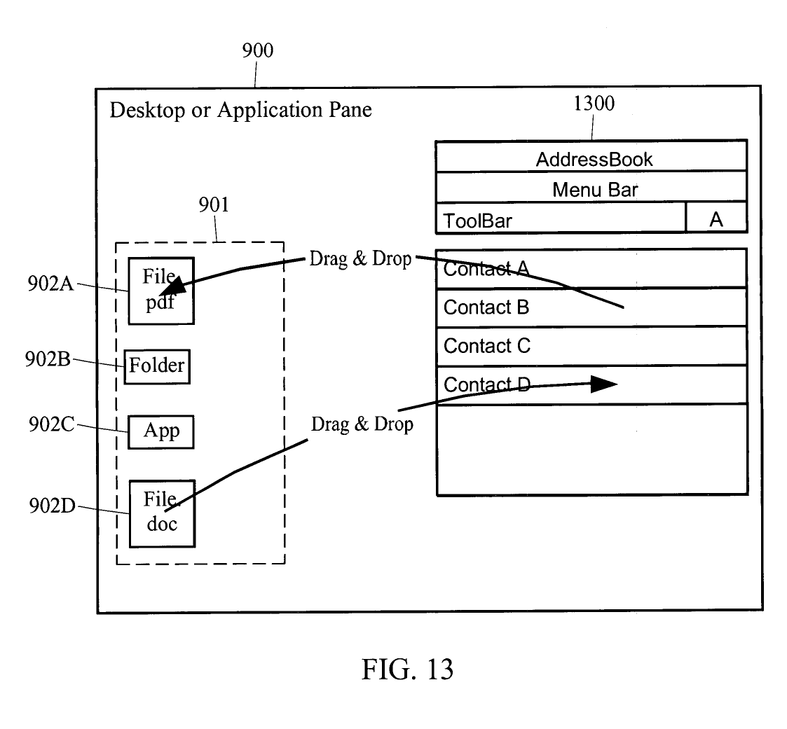

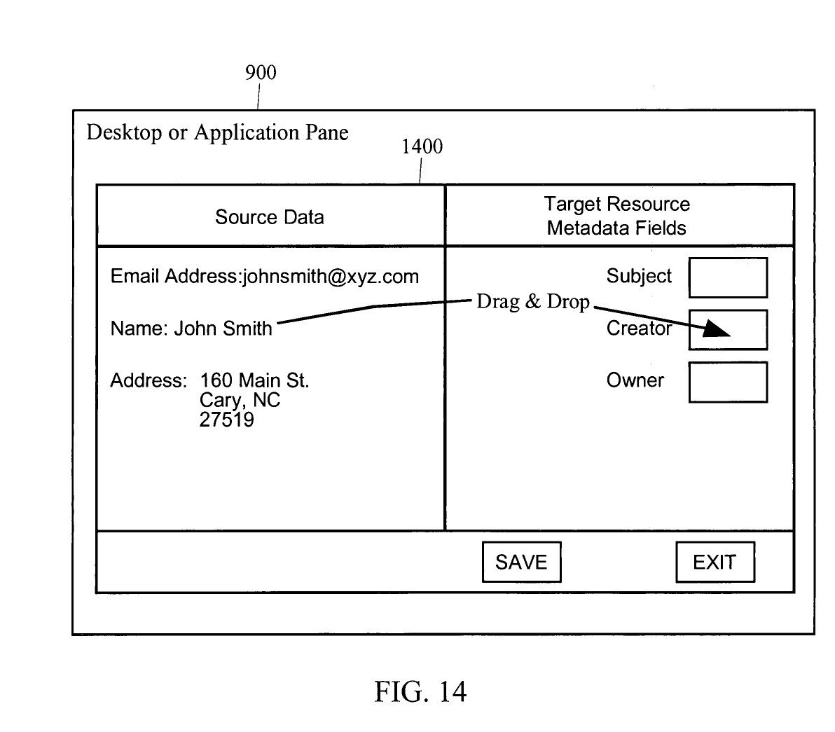

Returning to block 306 in FIG. 3A, if it is determined that mapable data is not present in the source resource, the entire source resource may be associated with the destination-resource. Accordingly, control may proceed to block 316 where the entire source resource is associated with the destination resource. Additionally, the decision made in block 306 may be predefined as “no” for certain source and/or destination resource types. For example, in the case of a contact associated with a contact management application, such as Microsoft Outlook®, it may be desirable to associate the entire source resource with the contact whether there is mapable data in the source resource or not. This example is shown below with reference to FIG. 13.

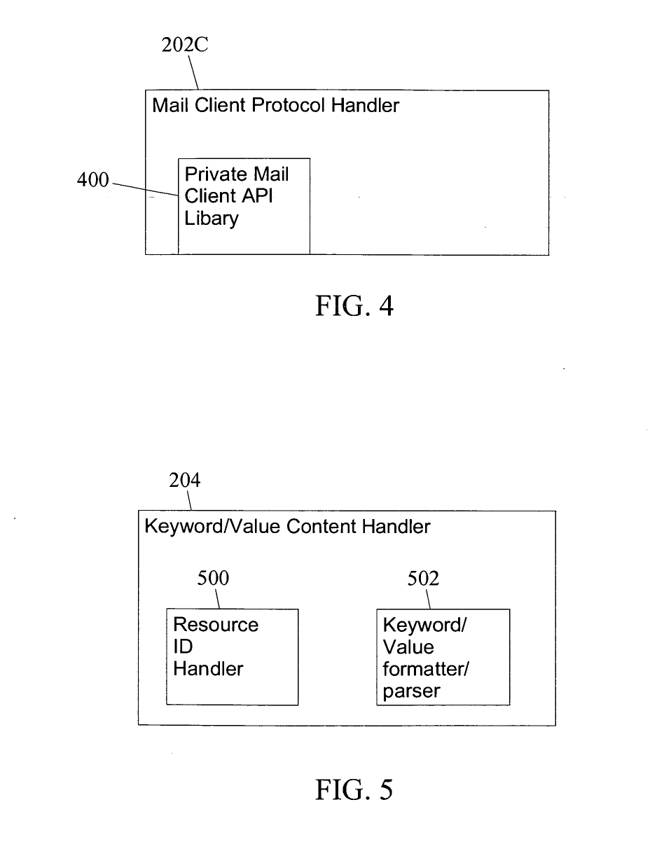

FIG. 4 is a block diagram illustrating an exemplary protocol handler 202C for a mail client. In FIG. 4, mail client protocol handler 202C uses a mail client proprietary application programming interface (API) library 400 to gain access to messages, folders, address books, or other data accessible via a mail client for which it may be desirable to associate with another resource as metadata or for which it may be desirable to associate data from another resource as metadata. Protocol handler 202C handles requests and responses to and from the mail client and forwards and receives data to and from the appropriate content handlers for the source and destination resources.

FIG. 5 is a block diagram of an exemplary content handler 204. In FIG. 5, content handler 204 is a generic content handler capable of parsing and formatting keyword/value pairs. Content handler 204 includes a resource ID handler for parsing resource identifiers received from hub 200 and a keyword/value formatter/parser 502 for interpreting keyword value pairs associated with a source or a destination resource. For example, data associated with a source or a destination resource may include metadata tags that correspond to the keywords and corresponding data values paired with each keyword.

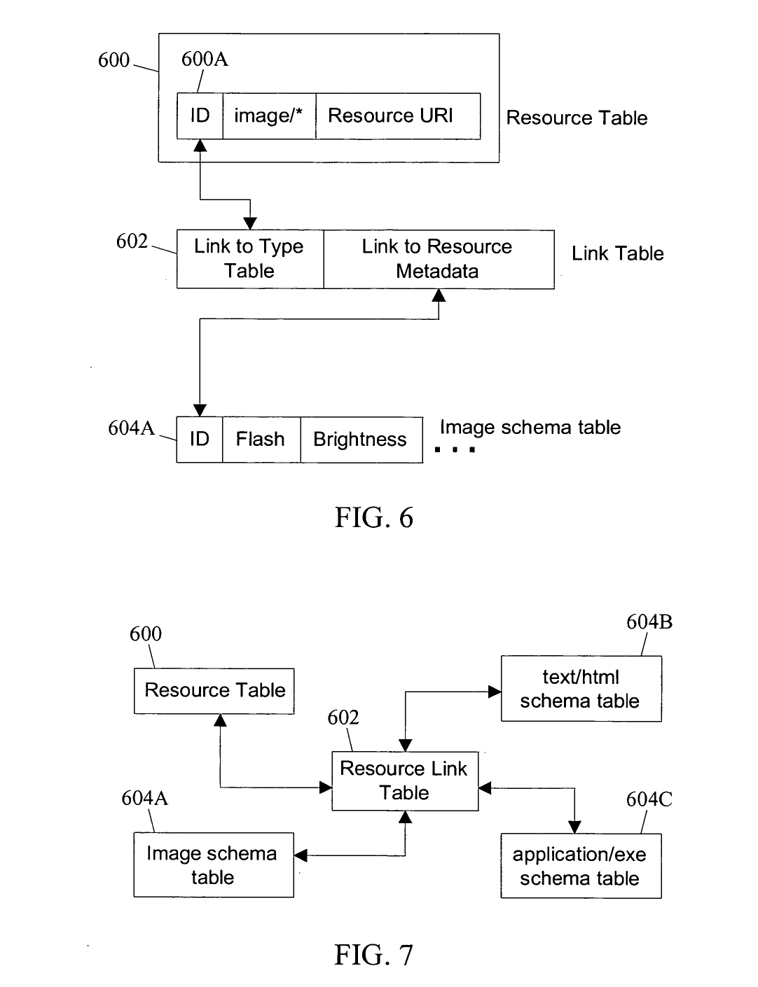

As stated above, metadata may be associated with a resource using entries stored in a metadata database. FIGS. 6 and 7 illustrate exemplary database structures that may be used to link metadata with resources. More particularly, FIG. 6 illustrates an example of a resource table, a link table, and a type table used to associate each resource with metadata. More particularly, in FIG. 6, a single resource table entry 600A of resource table 600 is shown for an image resource type. Entry 600A includes an identifier that links the resource to a link table 602. Link table 602 includes a link to an image schema table 604A that stores metadata for an image resource. FIG. 7 is a higher level view of the database illustrated in FIG. 6. As illustrated in FIG. 7, each resource type may include its own schema table 604A-604C that contains the associated metadata.

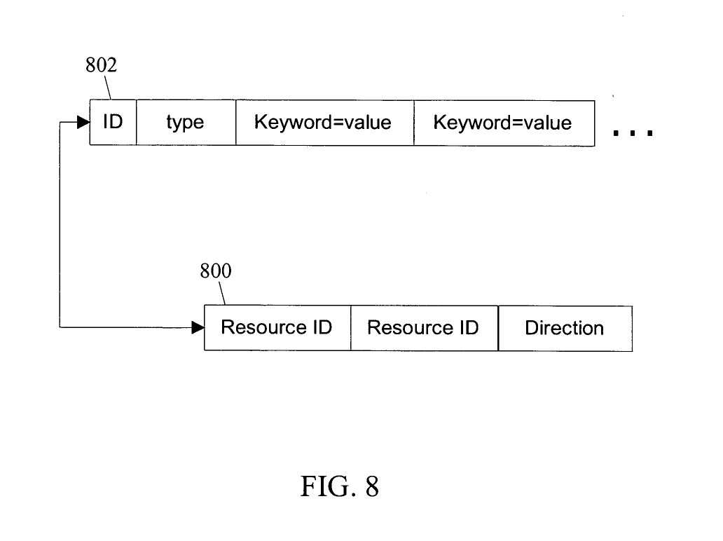

FIG. 8 illustrates an example of another data structure that may be used to associate a resource with metadata. In FIG. 8, the data structure includes a resource table 800 that stores a resource identifier and its type. A schema table 802 links the resource type to keyword-value pairs that represent metadata fields and data for each resource type.

In the examples illustrated in FIGS. 6-8, the relationships between the tables are shown as bidirectional. However, the subject matter described herein is not limited to bidirectional associations between resources and metadata. In an alternate implementation, the relationships may be unidirectional. Similarly, many-to-many, one-to-one, one-to-many, one-to-zero, and relationships with other cardinalities between resources and metadata are supported without departing from the scope of the subject matter described herein.

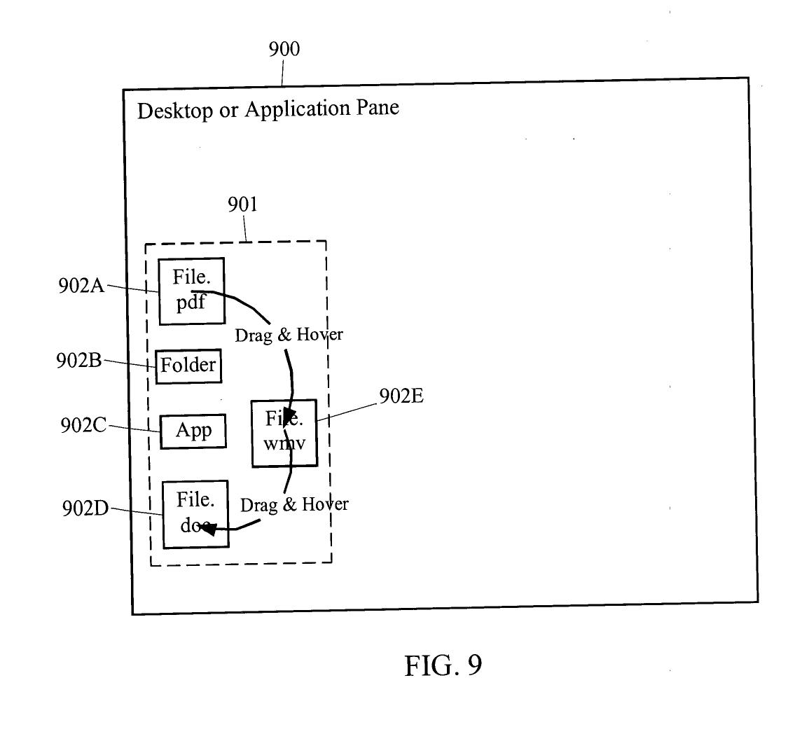

FIG. 9 is a block diagram illustrating an exemplary desktop or application pane associated with resource-to-resource metadata association according to an embodiment of the subject matter described herein. The desktop or application pane may be monitored by hub 200 illustrated in FIG. 2. Referring to FIG. 9, desktop or application pane 900 includes a plurality of resource representations 902A-902E. Resource representations 902A-902E may be graphical and/or textural representations of resources, as defined by the underlying operating system. In the illustrated example, a user selects a resource representation 902A that corresponds to a PDF file. The user drags resource representation 902A and hovers resource representation 902A over resource representation 902E and resource representation 902D. In response to this drag hover action, hub 200 may invoke the appropriate content handlers, protocol handlers, and transformer 205 for associating data from resource 902A with resources 902E and 902D. Alternatively, transformer 205 may be configured to associate data from resources 902E and 902D with resource 902A in response to this drag hover action. In one exemplary implementation, all appropriate data extracted from resource 902A may be automatically associated with resources 902E and 902D as metadata without further input from the user. In an alternate implementation, hub 200 may associate data from resource 902A with resources 902E and 902D for which mappings are defined in transform data store 206. If the transform is not defined for a particular source or destination resource, the user may be presented with a menu that allows the user to manually associate the unmapped data with the destination resource as metadata. An exemplary user interface for performing such mapping will be described in detail below. In yet another alternate implementation, data associated with the source resource may be displayed, metadata fields associated with the destination resource 902E or 902F may be displayed, and the user may manually select all of the mappings. The selected mapping may be saved and automatically applied in like scenarios in the future.

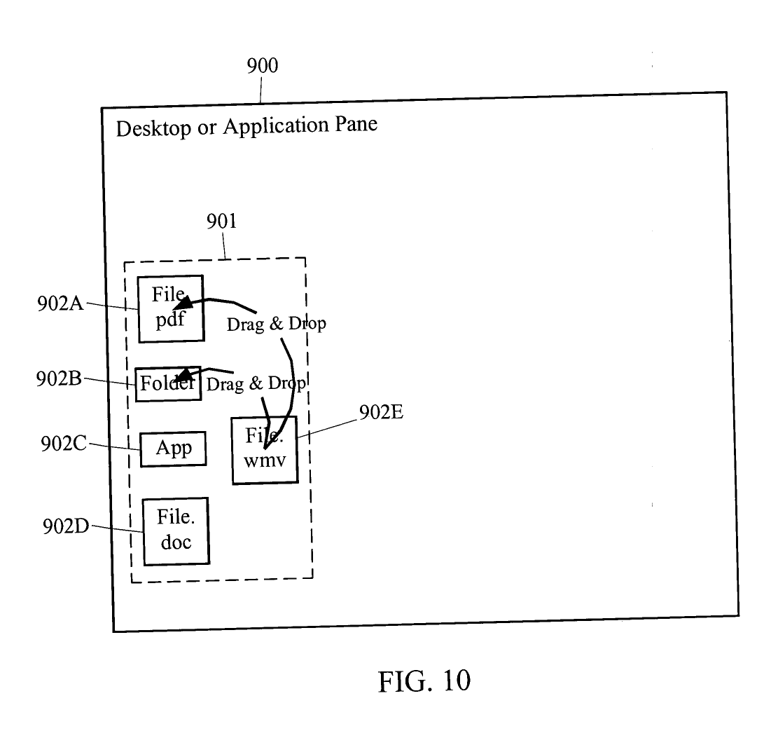

FIG. 10 is a block diagram illustrating desktop or application pane 900 in which the user performs resource-to-resource metadata association using drag-and-drop actions. In the example illustrated in FIG. 10, the user selects resource representation 902E, drags resource representation 902E over resource representation 902A and drops resource representation 902E onto resource representation 902A. The user repeats the same actions for dropping resource representation 902E onto resource representation 902B. The result of the two actions illustrated in FIG. 10 are the association of data extracted from the resource represented by resource representation 902E with resources represented by resource representations 902A and 902B as metadata. In FIG. 10, resource representation 902B is a file system folder. The data extracted from resource representation 902B may be data associated with the folder itself, may be data associated with resources linked to the folder, or may be data associated with both. In each case, the data associated with resource representation 902E as metadata as a result of drag-and-drop action will be independent of an association between resource representation 902E and the file system. For example, data indicating a path to a location in the file system or data indicating a category within the file system is not associated with resource representation 902E as a result of the drag-and-drop action. Again, as with the drag-and-hover actions described with reference to FIG. 9, transformer 205 can be configured so that the same drag-and-drop action illustrated in FIG. 10 results in the association of data extracted from the resource represented by resource representations 902A and 902B with resources represented by resource representation 902E as metadata.

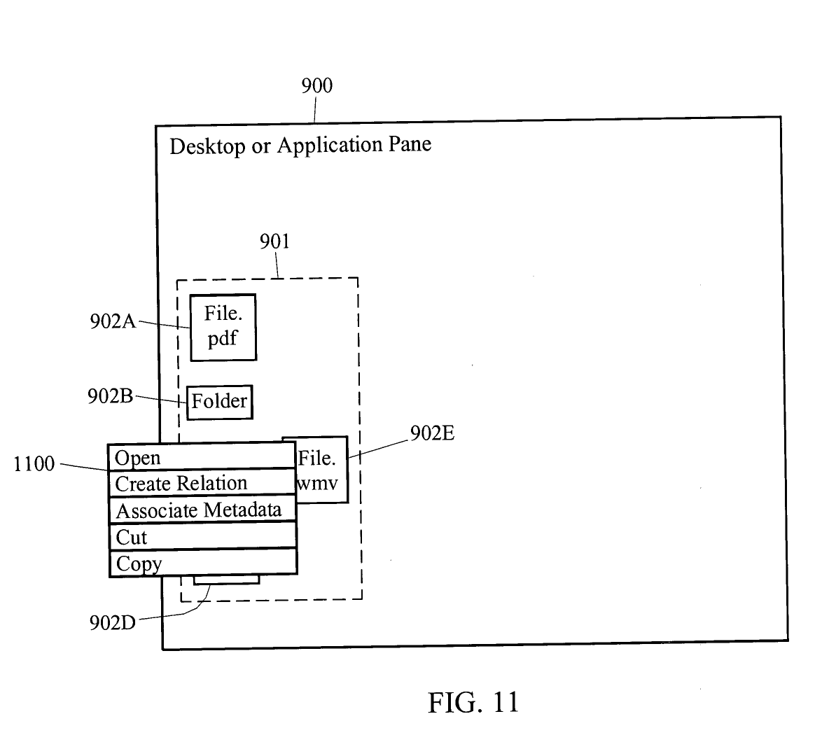

FIG. 11 is a block diagram illustrating yet another example of desktop or application pane 900 where the user performs resource-to-resource metadata association using modal input. By modal input, it is meant that once an indication is received to enter the metadata association mode, user input is interpreted in the context of the mode rather than normal desktop of application input processing. For example, in Windows®-based operating systems, a user can assign default actions to a context menu associated with a resource using a resource management interface, such as Windows Explorer®. In the illustrated example, it is assumed that a create relation action and an associate metadata action have been defined for resource 902E such that when a user clicks on resource 902E, menu 1100 appears with these options. The associate metadata action when selected causes the desktop or application pane to enter metadata association mode, allowing a user to associate metadata between source and destination resources using drag-and-drop or drag-and-hover, which would have other results in the normal desktop or application mode.

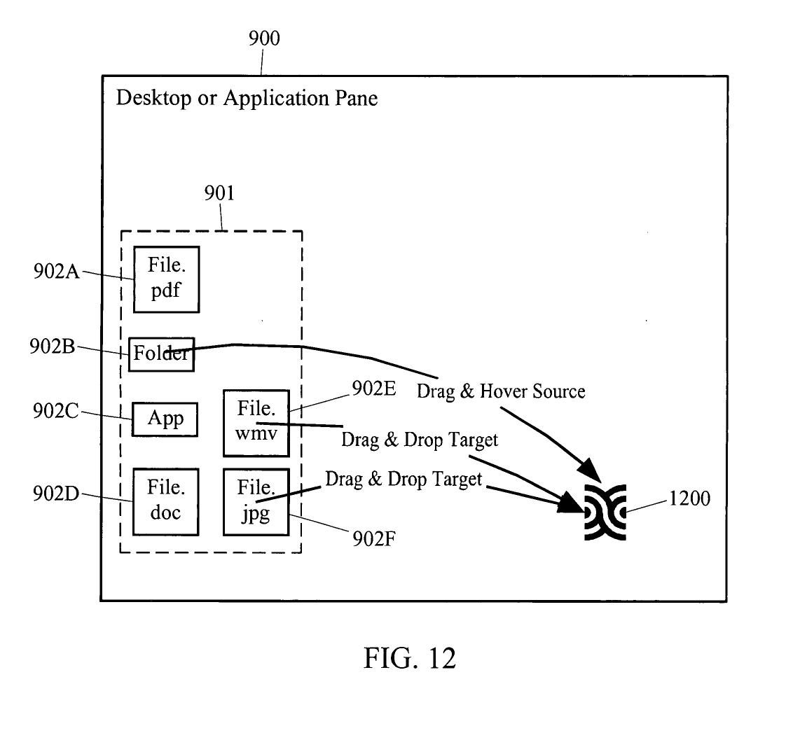

FIG. 12 is a block diagram illustrating another example of desktop or application pane 900 where resource-to-resource metadata association is performed using a metadata mixer. Referring to FIG. 12, a metadata mixer representation 1200 is displayed. Metadata mixer representation may represent access to an application that creates metadata associations between resources that are associated with it, such as hub 200. For example, if resources A and B are associated with metadata mixer representation 1200, metadata from resource A may be associated with resource B and vice versa. In the illustrated example, resource representations 902B, 902E, and 902F are associated with mixer representation 1200. Representation 902B is identified as a metadata source. Representations 902E and 902F are identified as metadata targets. Accordingly, data from the resource represented by representation 902B may be associated with the resources represented by representations 902E and 902F using the methods described above.

In order to distinguish between source and target resources, mixer representation 1200 may have two sides. For example, resources associated with the left side of mixer representation 1200 may be designated as targets and resource representations associated with the right side of mixer representation 1200 may be designated as sources. Alternatively, rather than using a two-sided mixer, a mouse gesture may be used to indicate a source resource and a different mouse gesture may be used to indicate a destination resource. In yet another alternate implementation, mouse gestures may be used in combination with keyboard input to distinguish between source and target resources. For example, the user may depress the S key after selecting a resource to identify that resource as the source and the D key after selecting a resource to identify the resource as a destination.

FIG. 13 illustrates another example of desktop or application pane 900 where data from an open application is associated with a resource as metadata and where a resource is associated with data from an open application as metadata. More particularly, in FIG. 13, an address book application 1300 displays contact information associated with an email address book. In the illustrated example, the user drags and drops contact B information on to resource representation 902A, which corresponds to a PDF file. In one implementation, the user may be presented with a menu or dialogue box that allows the user to select source data and corresponding target fields. FIG. 14 illustrates an example of such an interface. Referring to FIG. 14, desktop or application pane 900 includes a dialogue box 1400 that displays source data fields in the left hand column and target resource metadata fields in the right hand column. The user may select data in the left hand column and associate that data with the metadata fields in the right hand column by any suitable action, such as drag-and-drop or drag-and-hover. Once the user has defined all of the associations that the user desires to make, the user may select the save button to save the changes.

Although in the example illustrated in FIG. 14, only existing metadata fields associated with the destination resources are shown, the subject matter described herein is not limited to such an implementation. In an alternate implementation, the user may define and associate custom metadata fields and values for the source resource and custom metadata fields for the destination resource. The source content handler may allow custom metadata fields and data to be defined for and associated with the source resource. The destination content handler may allow custom metadata fields to be defined for and associated with the destination resource. A transform may be defined for mapping the data in the custom metadata fields from the source resource to the custom metadata fields of the destination resource. For example, once custom source and/or destination fields are defined, the user may perform the initial mapping from source data to destination fields manually using an interface such as that illustrated in FIG. 14. Metadata hub 200 may record the mappings and store the mappings in transform data store 206. The next time that resources of the type for which the transform was defined are associated with each other, transformer 205 may access transform data store 206, extract the mapping, and perform the association.

Returning to FIG. 13, in another example, a user may associate a resource representation 902D with data displayed in address book application 1300. For example, the user may associate a picture with a contact. Thus, the example illustrated by the lower arrow in FIG. 13 illustrates the association of an entire resource with a destination as metadata. That is, the resource represented by resource representation 902D becomes metadata of the destination, which in this case is the contact.

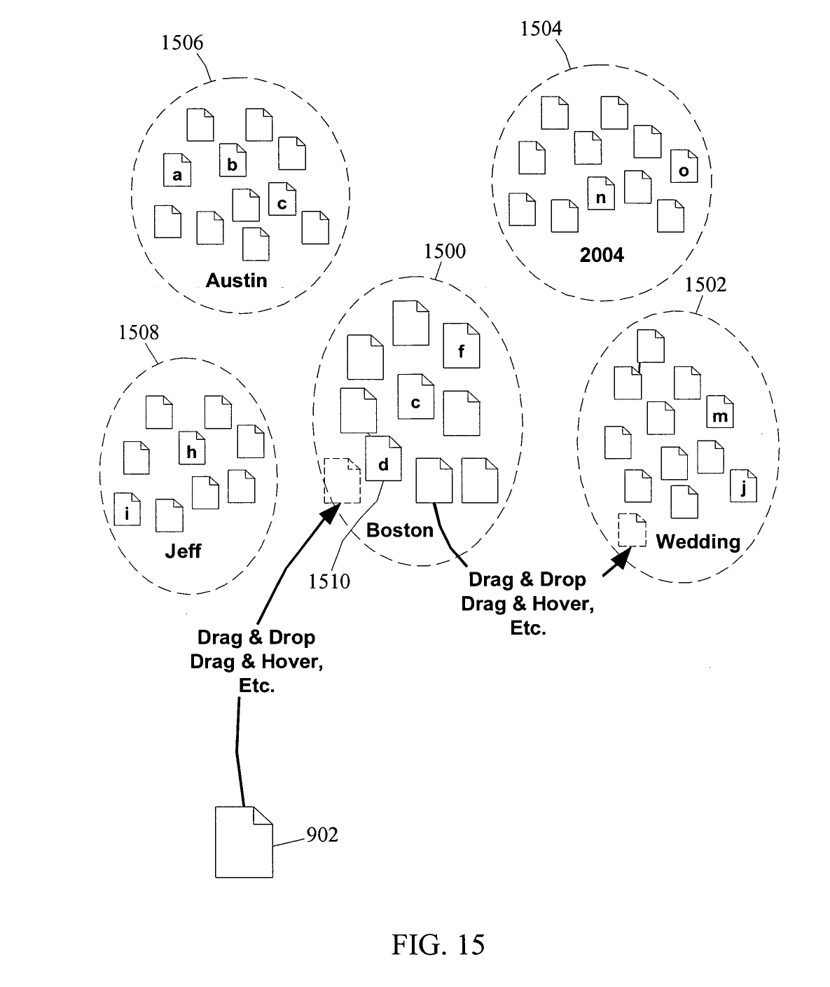

FIG. 15 is a block diagram illustrating another example of resource-to-resource metadata association according to an embodiment of the subject matter described herein. Referring to FIG. 15, resource clusters 1500, 1502, 1504, 1506, and 1508 each include multiple resource representations 1510 that have at least some metadata in common. For example, resource cluster 1500 includes the metadata “Boston”, which can be used in resource-to-resource metadata association. A user may move resource representation 902 to a location corresponding to one of the clusters and drop resource representation 902 onto the cluster or hover resource representation 902 over the cluster. Once the user performs the association action, data that is associated with the cluster as metadata may be associated with the resource represented by resource representation 902 or vice versa. It should be noted that resource representations can be members of more than one cluster. For example, in FIG. 15, resource representation ‘C’ is a member of two different clusters.

The following scenarios illustrate resource-to-resource metadata association according to an embodiment of the subject matter described herein.

Scenario 1:

1. Larry has a picture of Bob on his desktop. However, there is no metadata related to Bob associated with the picture.
2. Larry opens his address book and locates Bob's address book record.
3. He drags Bob's entry over the image and hovers over it until the image indicates that it has focus, and a rollover display pops up showing the metadata associated with the picture including the relevant info in the address book entry. When Larry releases the mouse, a dialogue box is displayed showing data from Bob's address book entry on one side. On the other side are image schema element names “creator,” “owner,” “subject.” Larry drags Bob's information onto the “subject.” (He later assigns his own address book entry to both “creator” and “owner” using the same UI operations.)
4. The picture was taken at Churchill Downs racetrack. Larry pulls up the home page for the track in his web browser. He selects the URL in the location bar via a copy operation and executes a paste from the context menu of the image. The content handler for the image adds the URL to the metadata as a relation.
5. Larry edits the metadata to indicate that the metadata is a location reference. Note: A protocol handler could have been used to retrieve the page and have it parsed by an HTML content handler into a format known to the image content handler, which would identify data from the page to associate with the image
   Scenario 2:
1. Larry has a picture of Bob on his desktop. He has captured metadata about Bob for the picture.
2. Larry uses his system search tool to find all resources either with “Bob” in the content or “Bob” in the metadata.
3. He drags and drops the picture of Bob onto the group of resources returned. Larry uses one of several keyboard sequences while hovering over the group to cause metadata associations to be made in one or both directions between the picture and the group of resources. (Note: conflicts can be resolved via a set of system and user configurable rules; and through dialogs allowing the user to take care of unresolved problems).
4. Bob's picture has also been embedded in a number of related resources such as his address book entry. Metadata has been exchanged between Bob's picture and the related resources.

It will be understood that various details of the invention may be changed without departing from the scope of the invention. Furthermore, the foregoing description is for the purpose of illustration only, and not for the purpose of limitation, as the invention is defined by the claims as set forth hereinafter.

What is claimed is:

1. A method for resource-to-resource metadata association, the method comprising:
identifying a source resource;
identifying an existing destination resource;
identifying a type of at least one of the source and destination resources;
selecting, based on the type, a transform for mapping at least one data value associated with the source resource to the destination resource as metadata; and
associating, based on the transform, a data value associated with the source resource with the destination resource as metadata;
wherein the metadata is independent of an association between the destination resource and a file system for storing the destination resource.

2. The method of claim 1 wherein identifying a source resource and identifying a destination resource includes monitoring user input for an action associating resources.

3. The method of claim 2 wherein monitoring user input includes identifying, based on the input, the source resource and the destination resource.

4. The method of claim 1 wherein associating, based on the transform, at least one of the data values associated with the source resource with the destination resource as metadata includes:
presenting a user with a menu of the data values associated with the source resource and metadata fields associated with the destination resource;
receiving input from the user regarding a data value associated with the source resource to be associated with a metadata field associated with the destination resource; and
associating, in response to the input, the data value with the metadata field.

5. The method of claim 4 wherein presenting a user with a menu of data values includes selecting data values associated with the source resource to be included in the menu based on the types of the source and destination resources.

6. The method of claim 4 comprising identifying a data value as a candidate for exclusion from the destination resource and wherein presenting the user with the menu includes listing the data value identified as a candidate for exclusion in the menu.

7. The method of claim 4 comprising identifying a data value as a candidate for exclusion from the destination resource and wherein presenting the user with the menu includes excluding the data value identified as a candidate for exclusion from the menu.

8. The method of claim 1 wherein associating, based on the transform, at least one data value associated with the source resource with the destination resource as metadata includes associating non-metadata associated with the source resource with the destination resource as metadata.

9. The method of claim 1 wherein associating based on the transform, at least one data value associated with the source resource with the destination resource as metadata includes associating metadata associated with the source resource with the destination resource as metadata.

10. The method of claim 1 wherein associating based on the transform, at least one data value associated with the source resource with the destination resource as metadata includes converting the at least one data value associated with the source resource to a format compatible with the destination resource.

11. The method of claim 1 wherein the source resource and the destination resources comprise files.

12. The method of claim 1 wherein the source resource comprises data accessible through an executing application and the destination resource comprises a file.

13. The method of claim 1 wherein the source resource comprises a file and the destination resource comprises data made available through an executing application.

14. The method of claim 1 wherein the source resource comprises a file and wherein the destination resource comprises a cluster of files.

15. The method of claim 1 wherein the source resource comprises a cluster of files and wherein the destination resource comprises a file.

16. The method of claim 1 further comprising associating at least one data value associated with the destination resource with the source resource as metadata.

17. The method of claim 1 comprising excluding, based on the transform, at least one of the data values associated with the source resource from association with the destination resource as metadata.

18. The method of claim 1 associating, based on the transform, metadata associated with the source resource and linked to a source metadata tag with the destination resource as metadata linked to a destination metadata tag, wherein the source metadata tag and the destination metadata tag have different values.

19. The method of claim 1 wherein associating, based on the transform, at least one of the data values associated with the source resource with the destination resource as metadata includes associating the entire source resource with the destination resource as metadata.

20. The method of claim 1 comprising defining a custom metadata field and associating the custom metadata field with the destination resource and wherein associating, based on the transform, at least one of the data values associated with the source resource with the destination resource as metadata includes associating a data value associated with the source resource with the custom metadata field.

21. The method of claim 21 wherein the data value associated with the source resource comprises a custom data value defined by a user.

22. The method of claim 21 wherein associating the data value with the custom metadata field includes receiving user input for associating the data value with the custom metadata field and recording a transform based on the user input.

23. The method of claim 22 comprising using the transform for associating data from a resource of the same type as the source resource with a resource of the same type as the destination resource as metadata.

24. A method for resource-to-resource metadata association, the method comprising:
presenting a user with a menu of data items extracted from a source resource;
presenting the user with a menu of metadata fields associated with a destination resource;
monitoring user input for association between a data item associated with the source resource and a metadata field associated with the destination resource; and
in response to detecting the user input, associating the data item from the source resource with the metadata field associated with the destination resource.

25. A system for resource-to-resource metadata association, the system comprising:
a transformer for applying a transform to map data from a first resource to a destination resource as metadata; and
a metadata hub for identifying at least one of a source and a destination resource type, for selecting the transform based on the at least one type, for invoking the transformer to map the data from the source resource to the destination resource as metadata, and for associating the data from the source resource to the destination resource as metadata, wherein the metadata is independent of an association between the destination resource and a file system for storing the destination resource.

26. The system of claim 25 wherein the metadata hub is adapted to receive identifiers for the source and destination resources from an operating system in response to user input for associating the resources.

27. The system of claim 25 wherein the metadata hub is adapted to present the user with a menu of data values associated with the source resource and metadata fields associated with the destination resource, to receive input from the user regarding a data value associated with the source resource to be associated with metadata field associated with the destination resource, and, in response to the input, to associate the data value with the metadata field.

28. The system of claim 27 wherein the metadata hub is adapted to select data values associated with the source resource to be included in the menu based on the types of the source of destination resources.

29. The system of claim 28 wherein the metadata hub is adapted to identify a data value as a candidate for exclusion from association with the destination resource as metadata and to include the data value identified as a candidate for exclusion in the menu.

30. The system of claim 28 wherein the metadata hub is adapted to identify a data value as a candidate for exclusion from the association with the destination resource as metadata and to exclude the data value from the menu.

31. The system of claim 25 wherein the transformer is adapted to map and associate a non-metadata data value associated with the source resource with the destination resource as metadata.

32. The system of claim 25 wherein the transformer is adapted to associate at least one metadata value associated with the source resource with the destination resource as metadata.

33. The system of claim 25 wherein the transformer is adapted to convert at least one data value associated with the source resource to a format compatible with the destination resource.

34. The system of claim 25 wherein the source and destination resources comprise files.

35. The system of claim 25 wherein the source resource comprises data made available through an executing application and the destination resource comprises a file.

36. The system of claim 25 wherein the source resource comprises a file and the destination resource comprises data accessible through an executing application.

37. The system of claim 25 wherein the source resource comprises a file and the destination resource comprises a cluster of files.

38. The system of claim 25 wherein the source resource comprises a cluster of files and the destination resource comprises a file.

39. The system of claim 25 wherein the metadata hub is adapted to associate at least one data value associated with the destination resource with the source resource as metadata.

40. The system of claim 25 wherein the metadata hub is adapted to exclude at least one of the data values associated with the source resource from association with the destination resource as metadata.

41. The system of claim 25 wherein the metadata hub is adapted to associate a first data value associated with the first metadata tag associated with the first resource with a second metadata tag associated with the destination resource, wherein the first and the second metadata tags have different values.

42. The system of claim 25 wherein the metadata hub is adapted to associate the entire source resource with the destination resource as metadata.

43. A system for resource-to-resource metadata association, the system comprising:
means for identifying a source resource;
means for identifying an existing destination resource;
means for identifying a type of at least one of the source and destination resources;
means for selecting, based on the type, a transform for mapping at least one data value associated with the source resource to the destination resource as metadata; and
means for associating, based on the transform, a data value associated with the source resource to the destination resource as metadata;
wherein the metadata is independent of an association between the destination resource and a file system for storing the destination resource.

44. A computer program product comprising computer-executable instructions embodied in a computer-readable medium for performing steps comprising:
identifying a source resource;
identifying an existing destination resource;
identifying a type of at least one of the source and destination resources;
selecting, based on the type, a transform for mapping at least one data value associated with the source resource to the destination resource as metadata; and
associating, based on the transform, a data value associated with the source resource to the destination resource as metadata;
wherein the metadata is independent of an association between the destination resource and a file system for storing the destination resource.

45. A computer program product comprising computer-executable instructions embodied in a computer-readable medium for performing steps comprising:
presenting a user with a menu of data items extracted from a source resource;
presenting the user with a menu of metadata fields associated with a destination resource;
monitoring user input for association between a data item associated with the source resource and a metadata field associated with the destination resource;
in response to detecting the user input, associating the data item from the source resource with the metadata field associated with the destination resource.
